(19) United States
(12) Patent Application Publication
(10) Pub. No.: US 2022/0416353 A1
(43) Pub. Date: Dec. 29, 2022

(54) BATTERY SUPPORTING STRUCTURE

(71) Applicant: TOYOTA JIDOSHA KABUSHIKI KAISHA, Toyota-shi (JP)

(72) Inventor: Yasuyuki Hihara, Nagoya-shi (JP)

(73) Assignee: TOYOTA JIDOSHA KABUSHIKI KAISHA, Toyota-shi (JP)

(21) Appl. No.: 17/842,251

(22) Filed: Jun. 16, 2022

(30) Foreign Application Priority Data
Jun. 23, 2021 (JP) 2021-103940

(51) Int. Cl. H01M 50/264; B60R 16/04; H01M 50/202; H01M 50/249

(52) U.S. Cl. CPC H01M 50/264; B60R 16/04; H01M 50/202; H01M 50/249; H01M 2220/20

(57) ABSTRACT

A battery supporting structure which supports a battery mounted on a vehicle is provided, which includes a battery tray on which the battery is mounted and to which a lower part of the battery is fixed, an upper support member that surrounds an upper side of the battery, a lower support member that surrounds a lower side of the battery, that is provided at a lower side of the battery tray, and that is fixed to a vehicle body, and a fastening member that fastens the upper support member and the lower support member.

### CROSS REFERENCE TO RELATED APPLICATION

This application claims priority to Japanese Patent Application No. 2021-103940 filed on Jun. 23, 2021, which is incorporated herein by reference in its entirety including the specification, claims, drawings, and abstract.

### TECHNICAL FIELD

The present disclosure relates to a supporting structure of a battery equipped on a vehicle.

### BACKGROUND

Vehicles are equipped with batteries which supply electric power to various devices. A battery, which is a heavy object, must be supported on the vehicle in a fixed manner because a large inertial force acts on the battery due to traveling of the vehicle. For example, JP 2016-222167 A discloses a supporting structure of a battery in which the battery is fixed on a battery tray on which the battery is mounted.

However, in the supporting structure of the battery disclosed in JP 2016-222167 A, when a large inertial force due to traveling of the vehicle acts on the battery, there is a possibility that the battery will become detached from the battery tray, and the battery will be released from the battery tray.

An aspect of the present disclosure lies in provision of a battery supporting structure which can prevent detachment of the battery from the battery tray and consequent release of the battery from the battery tray.

### SUMMARY

According to one aspect of the present disclosure, there is provided a battery supporting structure which supports a battery equipped on a vehicle, the battery supporting structure comprising: a battery tray on which the battery is mounted and to which a lower part of the battery is fixed; an upper support member that surrounds an upper side of the battery; a lower support member that surrounds a lower side of the battery, that is provided at a lower side of the battery tray, and that is fixed to a vehicle body; and a fastening member that fastens the upper support member and the lower support member.

In some embodiments, in the battery supporting structure, the upper support member and the lower support member are provided along a front-and-rear direction of the vehicle.

In some embodiments, in the battery supporting structure, the battery is fixed to the battery tray by fitting a recess provided at a lower part of a rear side surface of the battery to a protrusion provided at an inner side of a rear wall of the battery tray, and engaging a battery clamp in a gap between a recess provided at a lower part of a front side surface of the battery and a front wall of the battery tray, and the battery clamp is integrally formed with the upper support member.

According to a battery supporting structure of an aspect of the present disclosure, detachment of the battery from the battery tray and release of the battery from the battery tray can be prevented.

### BRIEF DESCRIPTION OF DRAWINGS

Embodiment(s) of the present disclosure will be described based on the following figures, wherein:

FIG. 1 is a perspective diagram showing a battery supporting structure according to an embodiment of the present disclosure;

FIG. 2 is a perspective diagram showing, from below the structure, the battery supporting structure according to the embodiment of the present disclosure shown in FIG. 1;

FIG. 3 is a perspective diagram showing the battery supporting structure from which a battery is removed;

FIG. 4 is a schematic cross sectional view of a battery and a battery tray along a short-side direction; and

FIG. 5 is a perspective diagram showing an upper support member.

### DESCRIPTION OF EMBODIMENTS

An embodiment of the present disclosure will now be described with reference to the drawings. In the following description, specifics for a shape, a material, a direction, a numerical values, or the like are merely exemplary for facilitating understanding of the present disclosure, and these parameters can be suitably changed according to usage, objective, specification, or the like.

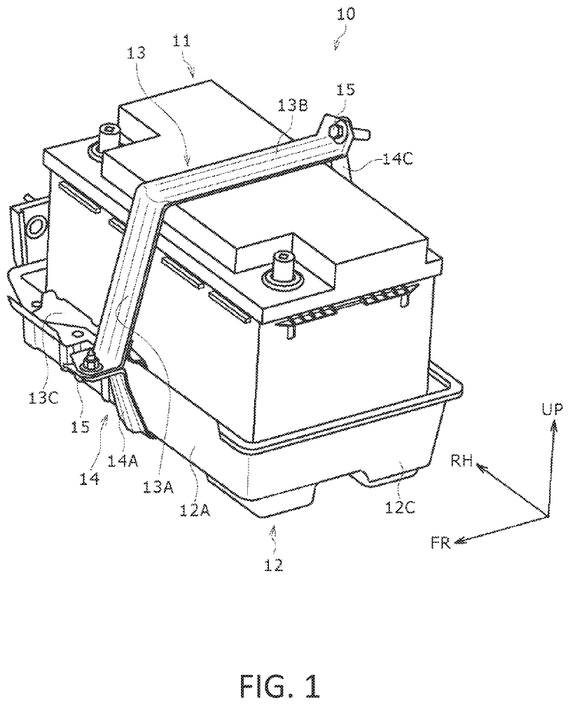

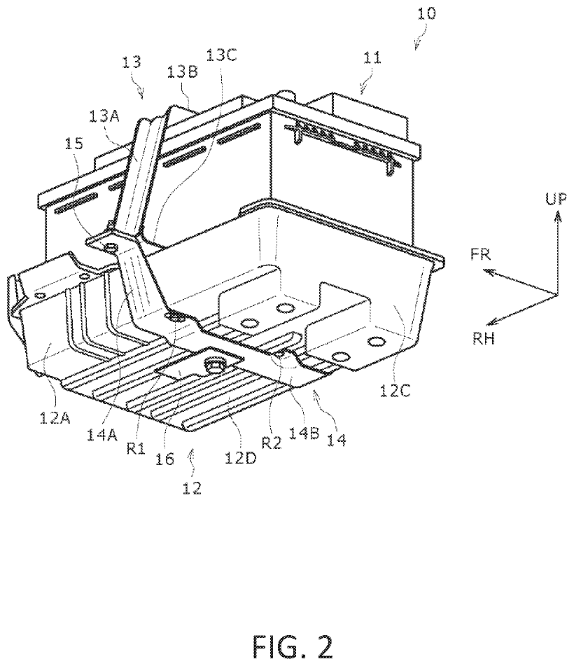

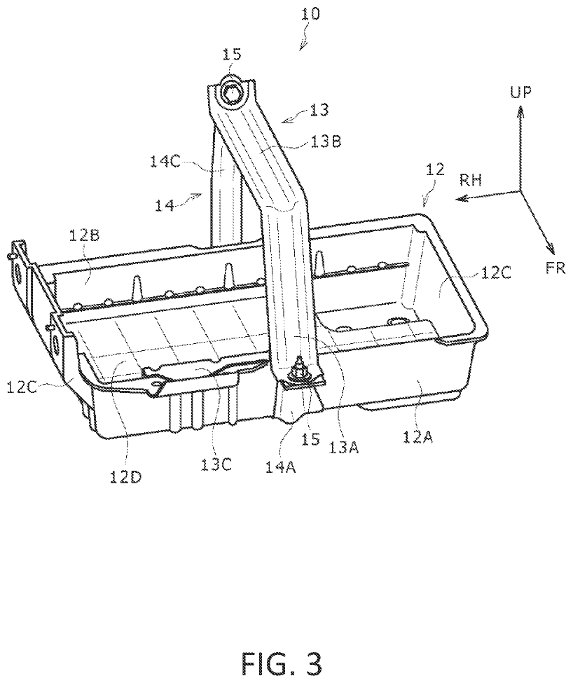

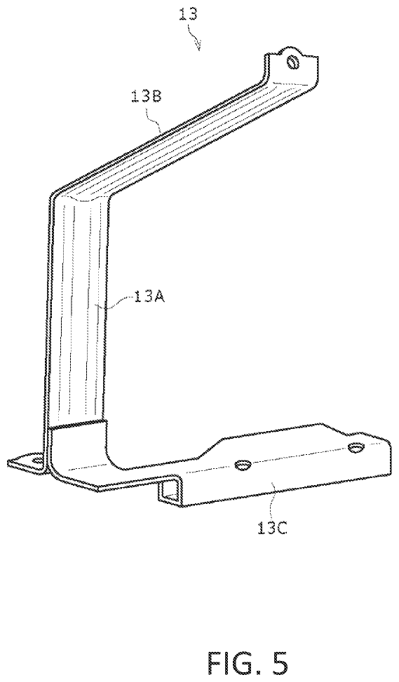

A battery supporting structure 10 according to an embodiment of the present disclosure will now be described with reference to FIGS. 1 to 5.

The battery supporting structure 10 is a structure which supports a battery 11 equipped on a vehicle. As will be descried later in detail, according to the battery supporting structure 10, it is possible to prevent detachment of the battery 11 from a battery tray 12 and release of the battery 11 from the battery tray 12. In addition, the battery 11 can be easily attached to and detached from the vehicle.

In the present embodiment, the vehicle is an engine-driven vehicle which travels with an engine providing motive power, but the vehicle is not limited to the engine vehicle. The vehicle may be any vehicle equipped with the battery 11, and may be, for example, a hybrid electric vehicle, an electrically driven vehicle, or a fuel cell electric vehicle.

The battery 11 supplies electric power to electrical equipment of the vehicle such as a cell motor which starts up the engine, a headlight, a brake lamp, a car audio system, a car navigation system, a powered window, a wiper, or the like. Alternatively, the battery 11 may be a battery which supplies electric power to a motor for traveling.

In the present embodiment, the battery supporting structure 10 is provided in an engine compartment at the front of the vehicle, in which the engine is housed, but the placement of the battery supporting structure 10 is not limited to this configuration. So long as the supporting structure supports the battery 11 on the vehicle, the location in the vehicle where the supporting structure is provided is not limited.

As shown in FIGS. 1 to 3, the battery supporting structure 10 comprises the battery tray 12 on which the battery 11 is mounted and to which a lower part of the battery 11 is fixed, an upper support member 13 which surrounds an upper side of the battery 11, a lower support member 14 which surrounds a lower side of the battery 11, which is provided at a lower side of the battery tray 12, and which is fixed to a vehicle body, and a fastening member 15 which fastens the upper support member 13 and the lower support member 14 at two locations.

The battery 11 is formed in an approximately rectangular parallelepiped shape. In the present embodiment, the battery 11 is placed on the vehicle in a “lateral placement” in which a short-side direction is parallel to a front-and-rear direction of the vehicle (an FR direction in the figures), and a long-side direction is parallel to a width direction of the vehicle, but the placement of the battery is not limited to the lateral placement. For example, the battery 11 may be placed on the vehicle in a “longitudinal placement” in which the short-side direction is parallel to the width direction of the vehicle (an RH direction in the figures), and the long-side direction is parallel to the front-and-rear direction of the vehicle.

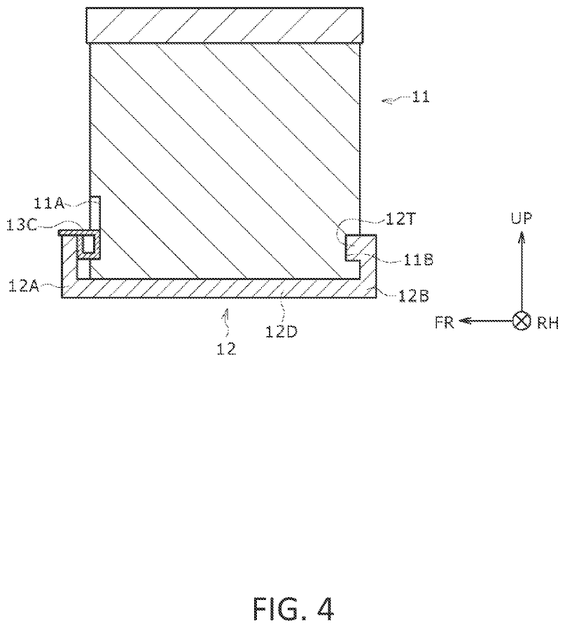

As shown in FIG. 4, the battery 11 is mounted on the battery tray 12, and the lower part of the battery 11 is fixed to the battery tray 12. A fixing structure of the battery 11 will now be described in detail.

At lower parts of respective side surfaces of the battery 11 in the short-side direction, recesses 11A and 11B are respectively formed. The recess 11A is provided at the front side in the front-and-rear direction of the vehicle, and the recess 11B is provided at the rear side in the front-and-rear direction of the vehicle.

As described above, the battery 11 is mounted on the battery tray 12. The battery tray 12 is formed by a resin material and in a box shape having an upper side opened. Because of the battery tray 12, even when an electrolyte solution of the battery 11 leaks, the leaked electrolyte solution can be recovered. In addition, as described above, with the battery tray 12, the lower part of the battery 11 can be fixed. Further, the battery tray 12 is fixed to the vehicle body.

More specifically, the battery tray 12 is formed from a front wall 12A, a rear wall 12B, two side walls 12C, and a bottom surface 12D. At an inner side of the rear wall 12B, a protrusion 12T to be fitted to the recess 11B of the battery 11 is formed. The lower support member 14 is fixed to the bottom surface 12D with a rivet or the like.

When the battery 11 is mounted and fixed on the battery tray 12, the battery 11 is mounted on the battery tray 12, and then, the battery 11 is slid to the rear side on the battery tray 12, so that the protrusion 12T of the battery tray 12 is fitted into the recess 11B of the battery 11. Further, a battery clamp portion 13C is engaged in a gap between the front wall 12A of the battery tray 12 and the recess 11A of the battery 11, so that the lower part of the battery 11 is fixed to the battery tray 12. The battery clamp portion 13C is integrally formed with the upper support member 13, which will be described later.

Referring again to FIGS. 1 to 3, as described above, the upper support member 13 is provided along the short-side direction (front-and-rear direction of the vehicle) of the battery 11, in a manner to surround the upper side of the battery 11. With the upper support member 13, it is possible to prevent detachment of the battery 11 from the battery tray 12 and the release of the battery 11 from the battery tray 12 due to an inertial force of the battery 11 in the front-and-rear direction of the vehicle, which is the direction in which the inertial force due to the traveling of the vehicle would normally act.

In the present embodiment, the upper support member 13 is provided along the short-side direction (front-and-rear direction of the vehicle) of the battery 11, but the placement is not limited to this configuration. For example, when the battery 11 is placed in the longitudinal placement, the upper support member 13 is desirably provided along the long-side direction (front-and-rear direction of the vehicle) of the battery 11. With this configuration, it is possible to prevent detachment of the battery 11 from the battery tray 12 and the release of the battery 11 from the battery tray 12 due to an inertial force of the battery 11 in the front-and-rear direction of the vehicle, which is the direction in which the inertial force due to the traveling of the vehicle would normally act.

As shown in FIGS. 1 to 3 and 5, the upper support member 13 is more specifically formed by folding a metal member having an elongated shape by approximately 90°, and comprises a front vertical portion 13A which opposes a front surface of the battery 11, and a horizontal portion 13B which opposes an upper surface of the battery 11. In addition, the upper support member 13 has the battery clamp portion 13C which is welded and joined to the front vertical portion 13A and which engages the battery 11 and the battery tray 12.

The front vertical portion 13A is provided with a predetermined spacing from the front surface of the battery 11. A lower end of the front vertical portion 13A is fastened and fixed to a front vertical portion 14A of the lower support member 14 by the fastening member 15.

The horizontal portion 13B is provided with a predetermined spacing from the upper surface of the battery 11. A rear end of the horizontal portion 13B is fastened and fixed to a rear vertical portion 14C of the lower support member 14 by the fastening member 15.

As described above, the battery clamp portion 13C engages in the gap between the recess 11A of the battery 11 and the front wall 12A of the battery tray 12. The battery clamp portion 13C is formed by folding, so as to have a predetermined width which is equal to a width of the gap in the front-and-rear direction of the vehicle. The battery clamp portion 13C is provided from a lower end of the front vertical portion 13A along an upper end of the front wall 12A of the battery tray 12.

According to the battery clamp portion 13C, the lower part of the battery 11 can be fixed to the battery tray 12, in addition to the fitting of the protrusion 12T of the battery tray 12 to the recess 11B of the battery 11.

In addition, according to the battery clamp portion 13C, because the battery clamp portions 13C is integrally formed with the upper support member 13, workability when the battery 11 is assembled can be improved in comparison to the battery supporting structure of the related art in which a battery clamp is provided as a separate component.

Further, with to the battery clamp portion 13C, because the battery clamp portion 13C is integrally formed with the upper support member 13, a fastening member for fixing the battery clamp on the battery tray 12, as provided in the battery supporting structure of the related art in which the battery clamp is provided as a separate component, can be omitted.

Referring again to FIGS. 1 to 3, the lower support member 14 is provided to surround the lower side of the battery 11 along the short-side direction (front-and-rear direction of the vehicle) of the battery 11, and is fixed to the vehicle body. According to the lower support member 14, because the lower support member 14 surrounds the battery 11 along with the upper support member 13 and is fixed to the vehicle body, it is possible to prevent detachment of the battery 11 from the battery tray 12 and the release of the battery 11 from the battery tray 12 due to an inertial force of the battery 11 in the front-and-rear direction of the vehicle, which is the direction in which the inertial force due to the traveling of the vehicle would normally act.

In the present embodiment, the lower support member 14 is provided along the short-side direction (front-and-rear direction of the vehicle) of the battery 11, but the placement is not limited to this configuration. For example, when the battery 11 is placed in the longitudinal placement, the lower support member 14 is desirably provided along the long-side direction (front-and-rear direction of the vehicle) of the battery 11. With this configuration, it is possible to prevent detachment of the battery 11 from the battery tray 12 and the release of the battery 11 from the battery tray 12 due to an inertial force of the battery 11 in the front-and-rear direction of the vehicle, which is the direction in which the inertial force due to the traveling of the vehicle would normally act.

The lower support member 14 is more specifically formed by bending a metal member having an elongated shape by approximately 90°, and comprises the front vertical portion 14A, a horizontal portion 14B, and the rear vertical portion 14C. The lower support member 14 is provided along an outer side of the battery tray 12.

The front vertical portion 14A is provided along an outer side of the front wall 12A of the battery tray 12. As described above, the upper end of the front vertical portion 14A is fastened and fixed to the front vertical portion 13A of the upper support member 13 by the fastening member 15.

The horizontal portion 14B is provided along a lower side of the bottom surface 12D of the battery tray 12, and is fixed to the bottom surface 12D by rivets R1 and R2. In addition, as described above, the horizontal portion 14B is fixed to the vehicle body. In the present embodiment, the horizontal portion 14B is fastened and fixed to a bracket 16 fixed to a frame which is a part of the vehicle body, by a fastening member. With this configuration, the upper support member 13 and the lower support member 14 are firmly fixed to the vehicle body, and it is possible to prevent detachment of the battery 11 from the battery tray 12 and the release of the battery 11 from the battery tray 12 due to an inertial force of the battery 11 in the front-and-rear direction of the vehicle.

The rear vertical portion 14C is provided along an outer side of the rear wall 12B of the battery tray 12. As described above, the upper end of the rear vertical portion 14C is fastened and fixed to the rear end of the horizontal portion 13B of the upper support member 13 by the fastening member 15.

The fastening member 15 fastens the upper support member 13 and the lower support member 14. The fastening member 15 more specifically fastens the lower end of the front vertical portion 13A of the upper support member 13 and the upper end of the front vertical portion 14A of the lower support member 14. In addition, the fastening member 15 fastens the rear end of the horizontal portion 13B of the upper support member 13 and the upper end of the rear vertical portion 14C of the lower support member 14. For the fastening member 15, a bolt and a nut are desirably used.

According to the fastening member 15, by fastening the upper support member 13 and the lower support member 14, the surroundings of the battery 11 can be enclosed, and the movement of the battery 11 in the front-and-rear direction of the vehicle due to the inertial force of the battery 11 in the front-and-rear direction of the vehicle, and the consequent release of the battery 11 from the battery 12, can be prevented. In addition, by loosening the fastening member 15, the upper support member 13 can be removed from the lower support member 14, and the battery 11 can be easily removed from the vehicle (battery tray 12).

The present disclosure is not limited to the embodiment described above and alternative configurations thereof, and various modifications and refinements are possible within the scope of the claims.

1. A battery supporting structure which supports a battery equipped on a vehicle, the battery supporting structure comprising:
a battery tray on which the battery is mounted and to which a lower part of the battery is fixed;
an upper support member that surrounds an upper side of the battery;
a lower support member that surrounds a lower side of the battery, that is provided at a lower side of the battery tray, and that is fixed to a vehicle body; and
a fastening member that fastens the upper support member and the lower support member.

2. The battery support structure according to claim 1, wherein
the upper support member and the lower support member are provided along a front-and-rear direction of the vehicle.

3. The battery supporting structure according to claim 2, wherein
the battery is fixed to the battery tray by fitting a recess provided at a lower part of a rear side surface of the battery into a protrusion provided at an inner side of a rear wall of the battery tray, and engaging a battery clamp in a gap between a recess provided at a lower part of a front side surface of the battery and a front wall of the battery tray, and
the battery clamp is integrally formed with the upper support member.
